(19) United States
(12) Patent Application Publication
(10) Pub. No.: US 2020/0009708 A1
(43) Pub. Date: Jan. 9, 2020

(54) Adjustable Wrench with Recessed Jaws

(71) Applicant: Steven Gehrke, Pawtucket, RI (US)

(72) Inventor: Steven Gehrke, Pawtucket, RI (US)

(21) Appl. No.: 16/152,638

(22) Filed: Oct. 5, 2018

Related U.S. Application Data
(60) Provisional application No. 62/693,561, filed on Jul. 3, 2018.

(51) Int. Cl. B25B 13/16; B25B 23/16; B25G 1/10

(52) U.S. Cl. CPC B25B 13/16; B25G 1/102; B25B 23/16

(57) ABSTRACT

An adjustable wrench with recessed jaws designed to effectively grip and rotate a hex nut. The adjustable wrench with recessed jaws has an elongated member with two opposing ends, wherein a handle is at one end and a head is at an opposing end. The head end has a pair of jaws, each jaw having a triangular notch therein such that the triangular notches are symmetrically aligned when each jaw is flush against the other. An adjustable screw is operably connected to the pair of jaws such that the adjustable screw is designed to increase a distance between the pair of jaws when rotated. In this way, a user is able to use the triangular notches to effectively grip and rotate a hex nut.

### CROSS REFERENCE TO RELATED APPLICATIONS

This application claims the benefit of U.S. Provisional Application No. 62/693,561 filed on Jul. 3, 2018. The above identified patent application is herein incorporated by reference in its entirety to provide continuity of disclosure.

### BACKGROUND OF THE INVENTION

The present invention relates to adjustable wrenches. More specifically, the invention provides an adjustable wrench with recessed jaws having a handle with an adjustable screw and a head with a pair of jaws, wherein each jaw has a triangular notch and is operably connected to the adjustable screw.

Many people use standard wrenches to tighten and loosen traditional nuts and bolts. However, it is common for the wrench to slip on the nut or bolt and damage the user or the bolt. Although adjustable wrenches are designed to be used on certain types of hex nuts, they must be positioned perpendicularly to the nut, which can be difficult for the user to accomplish depending on the placement of the nut. Additionally, users who experience difficulty loosening the bolt may accidently strip the bolt instead. Thus, an improved adjustable wrench with recessed jaws that can effectively tighten or loosen hex bolts is desired.

### SUMMARY OF THE INVENTION

In view of the foregoing disadvantages inherent in the known types of adjustable wrenches now present in the known art, the present invention provides an adjustable wrench with recessed jaws wherein the same can be utilized for providing convenience for the user when desiring to xxx.

The present system comprises an adjustable wrench with recessed jaws. An adjustable wrench with recessed jaws comprises an elongated member having two opposing ends, wherein a handle is disposed at one end and a head is disposed at an opposing end. The head end comprises a pair of jaws, each jaw having a triangular notch disposed therein such that the triangular notches are symmetrically aligned when each jaw is flush against the other. An adjustable screw is operably connected to the pair of jaws such that the adjustable screw is configured to increase a distance between the pair of jaws when rotated. In this way, a user is able to effectively grip and rotate a hex nut.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of an embodiment of the adjustable wrench with recessed jaws.

FIG. 2 shows a perspective view of an embodiment of the adjustable wrench with recessed jaws in use.

### DETAILED DESCRIPTION OF THE INVENTION

Reference is made herein to the attached drawings. Like reference numerals are used throughout the drawings to depict like or similar elements of the adjustable wrench with recessed jaws. The figures are intended for representative purposes only and should not be considered to be limiting in any respect.

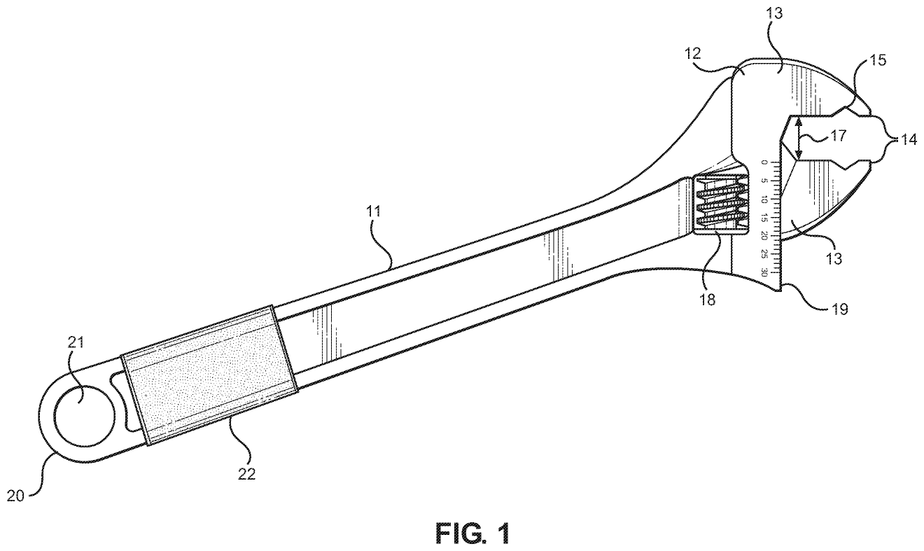

Referring now to FIG. 1, there is shown a top view of an embodiment of the adjustable wrench with recessed jaws. An adjustable wrench with recessed jaws comprises an elongated member having two opposing ends, wherein a handle 11 is disposed at one end and a head 12 is disposed at the opposing end. The handle 11 is sized such that it can be grasped with two hands by an individual and is thus of an appropriate length and width to accommodate the user.

The handle 11 includes an extremity 20, wherein the extremity 20 is disposed at a point distalmost from the head 12. An aperture 21 is disposed at the extremity 20, wherein the aperture 21 is configured to accept an item, such as a clip or ring, therethrough. In this way, a user can utilize the aperture 21 to carry the adjustable wrench with recessed jaws by affixing it to a ring of tools or hang the adjustable wrench with recessed jaws on a hook in a work place. In the shown embodiment, the handle 11 includes an inner recessed portion extending there along to provide a device with a reduced weight without impeding the structural integrity of the handle 11. In the illustrated embodiment, the aperture 21 has a diameter equivalent to the inner recessed portion of the handle 11, however in other embodiments the aperture 21 comprises a smaller surface area of the handle 11, such that it can fit snugly over smaller hooks, thus ensuring the adjustable wrench with recessed jaws does not fall off the hook.

In the illustrated embodiment, a padding 22 is disposed along a portion of the handle 11. The padding 22 is configured to provide a comfortable surface to a user when the user is gripping the handle 11. The padding 22 is composed of an ergonomic material, such as memory foam. In the shown embodiment, the padding 22 is disposed over a portion of the handle 11 immediately proximal to the aperture 21, however in other embodiments the padding 22 reaches from the aperture 21 to the head 12 of the adjustable wrench with recessed jaw. In this way, the user can grip the handle 11 with a greater strength and for a longer period of time without harming themselves or putting excessive strain on their hands.

The head 12 of the adjustable wrench with recessed jaws comprises a pair of jaws 13. Each jaw 13 tapers away from the handle 11, such that a jaw tip 14 is formed along the distalmost end of each jaw 13. In this way, the jaw tips 14 are configured to fit into tight spaces thereby giving the user greater maneuverability than would otherwise be available without tapering on the jaw tips 14. The jaws 13 are similar in nature to a traditional wrench, such that the jaw tips 14 are configured to grip a nut or bolt therein.

The jaws 13 further comprise a triangular notch 15 disposed along each body of the jaws 13. Each triangular notch 15 is disposed along an inner portion of each jaw 13, such that the triangular notch 15 opens towards a center of the jaws 13, with an apex pointed away from the center of the jaws 13. The triangular notches 15 are configured to align symmetrically when each jaw 13 is flush against the other, such that both triangular notches 15 are configured to have an equivalent size.

In the shown embodiment, the triangular notches 15 comprise equilateral triangles as the most common types of nuts and bolts have equivalently spaced faces. However in other embodiments the triangular notches 15 comprise isosceles triangles to better align to more specific varieties of nuts and bolts. In the illustrated embodiment, the triangular notches 15 are disposed proximal to the jaw tips 14. However, in other embodiments, the triangular notches 15 are disposed further from the jaw tips 14 such that the triangular notches 15 are proximal to the point where the jaws 13 affix to the head 12.

The triangular notches 15 give each jaw 13 two additional pressure points along each edge of the triangular notch 15. Thus, the triangular notches 15 provide an additional four pressure points to allow for a more effective grip on a hex nut or bolt. In this way, the triangular notches 15 allow the user to increase the amount of torque applied to the bolts when using the adjustable wrench with recessed jaws by providing additional pressure points where the bolt is in contact with the jaws 13.

Additionally, the triangular notches 15 allow a user to rotate the adjustable wrench with recessed jaws around the nut or bolt to attempt to tighten or loosen it from a parallel position, as opposed to the traditional position wherein the wrench must be perpendicular to the nut. In this way, the triangular notches 15 allow the user greater maneuverability when working.

One jaw is permanently affixed to the head 12 of the adjustable wrench with recessed jaws while the other jaw is operably connected to an adjustable screw 18, such that one jaw is station and the opposing jaw is slidable along the head in response to the actuation of the adjustable screw 18. In this way, when the adjustable screw 18 is rotated clockwise a distance 17 between the pair of jaws 13 is increased. Similarly, when the adjustable screw 18 is rotated in the opposite direction, the linear distance 17 between the pair of jaws 13, moving along a singular axis, is decreased. In this way, the adjustable screw 18 allows a user to accommodate a plurality of sizes of nuts and bolts when using the adjustable wrench with recessed jaws.

A ruler 19 having measurement indicia inscribed thereon is additionally disposed on the head 12 of the adjustable wrench with recessed jaws. The ruler 19 includes an indicator line connected to the jaws 13. The ruler 19 is configured to allow the user to determine the linear distance 17, such that the measurement indicated on the ruler 19 is equivalent to the linear distance 17. Thus, the start of the ruler 19 is aligned with an inner portion of the jaw 13 slidably disposed along the head, such that the measurement indicated by the ruler 19 corresponds to the linear distance 17. In this way, the ruler 19 allows a user to determine the linear distance 17 using the ruler 19 while rotating the adjustment screw 18.

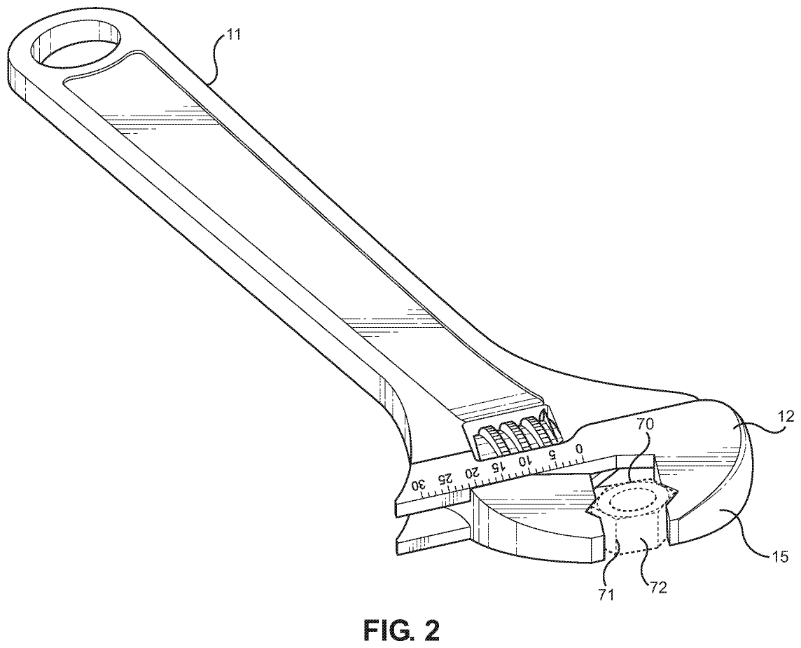

Referring now to FIG. 2, there is shown a perspective view of an embodiment of the adjustable wrench with recessed jaws in use. In operation, a user desiring to tighten or loosen a hex nut or bolt 70 will grip the handle 11 with at least one hand and affix the head 12 around the hex nut 70. The user will adjust the distance between the jaws 13 such that the jaws 13 enclose the hex nut 70 with an edge 71 of the hex nut 70 aligned with the apex of the triangular notches and the faces 72 of the hex nut 70 aligned with the edges of the triangular notches. In this way, the user can effectively grip the hex nut 70 with the adjustable wrench with recessed jaws and easily rotate the hex nut 70.

It is therefore submitted that the instant invention has been shown and described in various embodiments. It is recognized however, that departures may be made within the scope of the invention and that obvious modifications will occur to a person skilled in the art. With respect to the above description then, it is to be realized that the optimum dimensional relationships for the parts of the invention, to include variations in size, materials, shape, form function and manner of operation, assembly and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) An adjustable wrench with recessed jaws, comprising:
an elongated member having two opposing ends, wherein a handle is disposed at one end and a head is disposed at an opposing end;
the head end comprising a pair of jaws;
each jaw having a triangular notch disposed therein such that the triangular notches are symmetrically aligned when each jaw is flush against the other;
an adjustable screw operably connected to the pair of jaws such that the adjustable screw is configured to increase a distance between the pair of jaws when rotated.

2) The adjustable wrench with recessed jaws of claim 1, wherein a ruler is disposed along the adjustable screw.

3) The adjustable wrench with recessed jaws of claim 1, wherein each jaw tapers away from the handle such that a jaw tip is formed along the distalmost end of each jaw.

4) The adjustable wrench with recessed jaws of claim 1, wherein the handle includes a padded grip.

5) The adjustable wrench with recessed jaws of claim 4, wherein the padded grip extends across an entire length of the handle.

6) The adjustable wrench with recessed jaws of claim 1, wherein an aperture is disposed along the handle.

7) The adjustable wrench with recessed jaws of claim 1, wherein an inner section of the handle is recessed.

8) The adjustable wrench with recessed jaws of claim 7, wherein an aperture with a diameter equivalent to the recessed inner section of the handle is disposed at a distalmost point of the handle.

9) The adjustable wrench with recessed jaws of claim 1, wherein each triangular notch comprises an equilateral triangle.

10) The adjustable wrench with recessed jaws of claim 1, wherein each triangular notch is disposed on an inner edge of a respective jaw.

11) The adjustable wrench with recessed jaws of claim 10, wherein each triangular notch opens towards a center of the jaws such that an apex of the triangular notch is pointed away from the center of the jaws.
